(19) United States
(12) Patent Application Publication
(10) Pub. No.: US 2022/0327647 A1
(43) Pub. Date: Oct. 13, 2022

(54) WEB BASED SYSTEM FOR EXCHANGE OF INFORMATION WITH SELF-INITIATED TERMS AND CONDITIONS AND METHOD OF WORKING

(71) Applicant: Deepthireddy Santhekuldur, Cupertino, CA (US)

(72) Inventor: Deepthireddy Santhekuldur, Cupertino, CA (US)

(21) Appl. No.: 17/301,583

(22) Filed: Apr. 8, 2021

(51) Int. Cl. G06Q 50/18; G06Q 50/00; G06Q 30/08; G06Q 10/10; G06F 16/9535; H04L 29/06

(52) U.S. Cl. CPC G06Q 50/188; G06Q 50/01; G06Q 30/08; G06Q 10/101; G06F 16/9535; H04L 65/4015

(57) ABSTRACT

A system for term based secure information exchange is provided where the system is made of a web based mediator platform and a centralized server. The information includes a personal information (PII), social information, financial information as well as other specific context related information between the parties in exchange of any commercial gain of the information sharing party. The web based mediator platform of present system allows user to access the platform using any smart user device, select a terms for information exchange from the preset terms over the platform or create custom terms, create a terms link or code with the selected terms, and publish or share said term link or code over various web touch points over internet. According to present embodiment, the system allows any second party wants to access information of first party to review the terms, accept and then allows to exchange the information.

### FIELD OF INVENTION

The present invention relates to the field of computer implemented system and method of working of the same for confidently exchange of information and conduct a commerce against the exchange of the information between multi-parties, with self-initiated terms and conditions and exchange templates.

### BACKGROUND OF INVENTION

Generally, information is exchanged between multiple users by different requests and processing methods; but when it comes to Business-Business or Business-Consumer or Consumer-Business exchange, information is requested by one party and others just provide it for some material exchange (information or in other forms). In a way this is one side request and intake of information with no rules, and the information can be used by the other party for their significant gains at the same time without effective retention and removal policies.

Also, the insights of this information can be combined with other information from different sources used to extract value from the information chain. In some cases, information can be given and/or sold to other business entities or partner entities without an approval from users, where the information may consist of a personal information (PII), social information, financial and other.

This has become a serious issue with privacy, security, and processing concerns of users, as their data is prone for sale & misuse without their approval. With growing players in the information exchange field without rules, there is a real need for Information mediation with on demand exchange including self-driven rules/terms. With increasing privacy regulations across globe, businesses are unable to effectively market their products to relevant consumers and unable to realize return on investment.

To overcome such issue, many inventions have been made, one such of which is U.S. Pat. No. 8,185,932B2 that discloses a system and method for user-centric authorization to access user specific information. According to this invention, in a network computing environment, a user-centric system and method for controlling access to user-specific information maintained in association with a web-services service. When a web-services client desires access to the user-specific information, the client sends a request. The request identifies the reasons/intentions for accessing the desired information. The request is compared to the user's existing access permissions. If there is no existing access permission, the request is compared to the user's default preferences. If the default preferences permit the requested access, an access rule is created dynamically and the client's request is filled, without interrupting the user. If the default preferences do not permit the request to be filled, a consent user interface may be invoked. The consent user interface presents the user with one or more consent options, thereby permitting the user to control whether the client will be given access to the user-specific information.

But the limitation present in existing inventions is that they fail to provide control of user over their personal data thus compromising their privacy, security, protection and refrain them from getting any commercial benefit from their data. Further, the present solutions do not address need of confidently sharing of a personal information under the agreement of terms and conditions of the user by the information seeking party. The business which seeks the personal first party information of user are unable to obtain it or fails to have dialogue with the user directly.

Therefore, there exists a need of a web based mediation platform which may address timebound exchange, data privacy, security and protection of information of any user. Further, there exists a need of a platform that may allow user to confidently exchange information thereby improving collaboration and commercial benefits between the parties. Moreover, there exists a dire need of a platform that may enable business to realize marketing potential of their data, allowing them to exchange relevant information on demand through the web based mediation platform of present invention.

### SUMMARY

The present disclosure overcomes one or more shortcomings of the prior art and provide additional advantages discussed throughout the present disclosure. Additional features and advantages are realized through the techniques of the present disclosure. Other embodiments and aspects of the disclosure are described in detail herein and are considered a part of the claimed disclosure.

The subject matter of present invention provides a system with a computer implemented platform for information exchange with privacy, security and protection for consumers. The present platform eliminates misuse of consumer information by exchange of information only under the terms and conditions agreed by both the parties. Most importantly, the platform of present system allows business or any party who seeks information from the first party to have dialogue with the first party directly over the platform and come under the deal with the first party in exchange of information. Terms based flow of information will significantly improve trust to communicate and conduct commerce.

According to one embodiment, the present system and a web based platform provides solution to the current e-marketing approaches which are failing in terms of recognizing return on investment (ROI). The present system provides solution for many existing limitations of current information exchange methods such as companies at present are unable to properly market their product and service, in particular, via email marketing without prior opt-in & no cookie based tracking; companies are not realizing their return on investment on search marketing and hence wasting their money with redundant clicks or No-value clicks; companies buying leads from third party providers without consent of the user or without any traceable source for communication.

The present system terms based information exchange between the parties or users over the platform of present system. The system provides a computer implemented platform that allows user to establish standard set of terms or create custom terms along with parameters using which the platform controls exchange of information, privacy, security and protection of data being exchanged. The platform of present system creates a term link or a term code for the terms selected by the user and allows the user to distribute or publish said term link/code at various web touch points where user is present or allows user to provide the link on demand by any second user who desired to access terms and acquire the information from the first user.

The system through the web based platform allows any second user who is interested in consuming information of first user may access and review the terms of the first user through the term link/code published by the user over the web touch point or by directly demanding from the user over the platform and if the second user may adhere to the terms of the first user then the platform allows to securely exchange the information under said terms. According to one embodiment, if the second user feels the terms are not acceptable and impractical, it may negotiate with the first user by proposing their offered terms. Further, the system allows second user to request directly over the platform, in case the second user requires any special context information or personal information from the first user.

According to one embodiment, the present system with a web based platform provides more relevant search results to the user with privacy, security and retention terms agreed on before engagement in a deal. The web based platform and present system further allows to directly enter the term code or link at any web front end instead of filling information. Furthermore, the platform allows user to enter terms code instead of sign in or registration on any web based platform which saves time as well as prevents repetition of information and avoids security breaches on network.

### BRIEF DESCRIPTION OF DRAWINGS

The foregoing summary, as well as the following detailed description of the invention is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a high level process flow diagram of present web based terms and condition driven information exchange system.

FIG. 2 illustrates process flow diagram for terms setup and exchange process initiation of system.

FIG. 3 shows flow diagram of initiation of information exchange through touch points.

FIG. 4 shows a process flow diagram of terms agreement between the parties and negotiation between the parties.

FIG. 5 illustrates view of a process flow diagram of initiation of an information exchange between the parties through the present web based platform.

FIG. 6 shows process flow diagram of multi-parties terms approval and information exchange.

FIG. 7 shows process diagram of advance information exchange and deal making.

FIG. 8 shows a process diagram for deal realization and commerce between the parties.

FIG. 9 shows view of process diagram of information exchange closure, completion or re-initiation.

### DETAILED DESCRIPTION OF INVENTION

The present invention overcomes the aforesaid drawbacks of the above, and other objects, features and advantages of the present invention will now be described in greater detail. Also, the following description includes various specific details and are to be regarded as merely exemplary. Accordingly, those of ordinary skill in the art will recognize that: without departing from the scope and spirit of the present disclosure and its various embodiments there may be any number of changes and modifications described herein.

The web based mediator platform for secure information exchange under the agreement of terms and conditions between the parties are provided. According to one embodiment, the information between the parties includes personal information (PII), social information, financial information as well as other information of parties in exchange. According to one embodiment, the information exchange can be done between individual-individual users, between business and individual or between businesses.

According to one embodiment, the present web based platform provides control of the user over their information privacy, security and commerce. The platform of present invention directly connects the parties one to share information and other to acquire it in exchange of something legitimate thus enabling any business to obtain customer's first party information and have dialogue with them directly through the platform.

According to one embodiment, present invention provides a platform that allows business or any user to communicate with other business or user with own rules by using three simple steps of; entrance of term code by first business or user, acceptance of terms by second business or user, and then exchange of information between parties. The computer implemented platform of present invention, according to one embodiment, first allows user to establish standard set of terms from the platform or create custom terms along with parameters which controls timebound exchange, security, privacy and data protection of the user.

According to one embodiment, the platform creates a term link or term code with the selected terms of the user and allows the user to distribute or publish that term link or code at all web touch points where the user is present. Further, the user being an individual or company may further provide on demand the term link or code to any other user to access the terms and conditions. The second user (consumer or business) which is interested in consuming information may access the terms via term link, review the terms (manual or automated) and if it can adhere to terms then it can start information exchange with the first user.

According to one embodiment, the present web based platform behaves as a mediation system to handle all the communication between the concern parties who are in exchange of information over the platform. The web based platform allows business to access the specific information of user such as any advance data like personal information (PII) of user or any special context information by requesting to the user for a deal through a platform.

The web based system allows business to match the terms of the user with their term acceptance limit before accepting terms and initiating the process of information exchange. Further, the platform allows business to negotiate terms with the user in case any term of the user is unacceptable by proposing their own new offered term which user may review and accept to initiate information exchange and/or reject and opt for further term negotiation.

According to one embodiment, the process of information exchange initiates from the selection of the terms from already existing terms over the platform or by custom creation of terms by the user for information exchange. The web based platform generates a term code or a term link with elected set of terms by the user, once the user selects a set of terms and shares said term code over any web touch point of the user where the user is available. Once the user creates a term link/code by selecting terms, the web based platform of present invention checks to see if the terms are acceptable and signals ready for the information exchange. The computer implemented platform of present system, after acceptance of terms between the parties, recommends templates to the user based on the context or information requirement from the user which user may fill up. According to one embodiment, the system of present invention then initiates presenting the information related to user requested information by the business.

According to one embodiment, for cases of advanced information from the user, the system through the platform sends information exchange template to be filled by the user and presents a deal with the user for approval from the user and based on the approved deal, the system shares the detail with the business or party which needed the information. Further, based on the agreed deal, the system allows user to perform commerce with the interested parties.

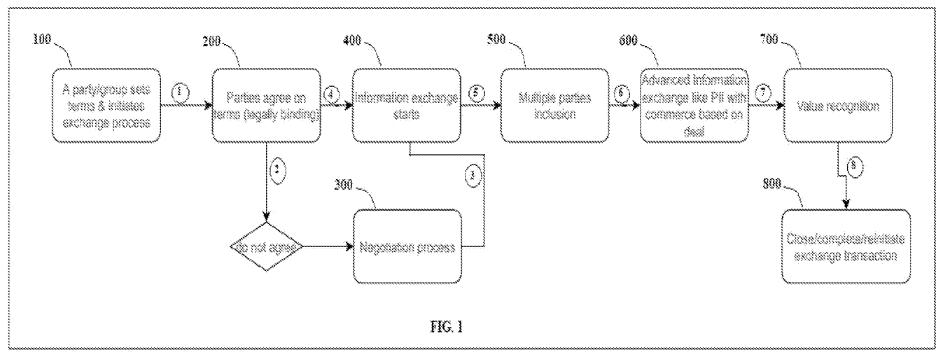

Referring to FIG. 1 now which shows high level process flow diagram of one exemplary embodiment of present web based secure information exchange system 1000 and a platform. According to present embodiment, the present system 1000 includes a central server and a computer implemented platform accessible through any network enabled user device such as smartphone, computer, laptop or any other wearable smart device. The computer implemented platform of present system 1000 provides a medium for the users such as any consumer or business to acquire details of any other consumer or business under specific terms and condition selected by the first consumer or business and accepted by the second party. According to present embodiment, the information includes any specific context specific information or personal information (PII) or any other information.

According to present embodiment, the system 1000 allows users to exchange the information through the platform via multiple stage process, wherein the platform allows the party or group to set a terms and initiate the exchange process 100 as step 1 of the process of secure data exchange. Once the terms are set by the first party sharing the information, the platform sends the terms to the second party which is in need of information for their review. The system allows the second party to agree on terms 200 which legally binds the parties. If the second party does not agree over the terms of the first party at step 2, the system 1000 provides a window of negotiation between the parties and starts a negotiation process 300 as step 3 then the process of information exchange over the web based platform of the present system 1000 initiates.

According to one embodiment, multiple parties can also initiate the term process 500 wherein they all initiates same set of terms to other parties for approval. According to present embodiment, the system 1000 and the computer implemented platform further allows user to exchange advance information like PII with commerce and/or return economic benefit to the party sharing information based on the deal 600. Based on the deal, if the information sharing party is a business, it can recognize value 700 of the information being shared and accordingly complete a deal. After acceptance, the platform completes sharing of an information or reinitiates exchange transactions 800.

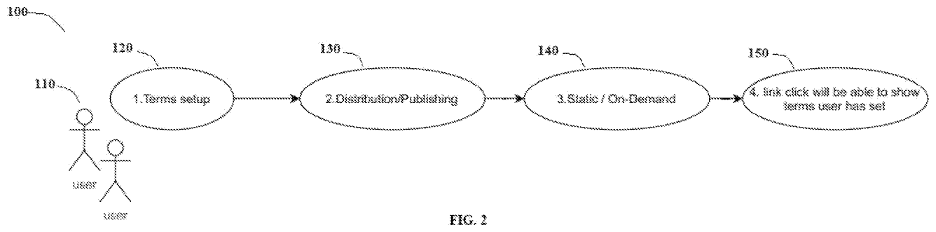

subsequent figures illustrates each stage from whole process or method of working of the platform of present system 1000 at each stage. FIG. 2 shows process flow diagram of terms setup and information exchange process initiation stage 100 of present system 1000. According to present embodiment, under this initial stage, the system 1000 of present invention provides a computer implemented web based platform to users 110 to setup their terms 120 for sharing information with any other user/party over the platform. The system 1000 then allows user to distribute or publish 130 their set of terms in the form of code or link over different touch points over the web.

According to present embodiment, the system 1000 of present invention under this initial stage 100 allows user or requestor to ask any specific or personal information from the user on-demand 140. The created link of terms over the touch points allows information requestor user to click over the link to see the terms user has set in exchange of information 150.

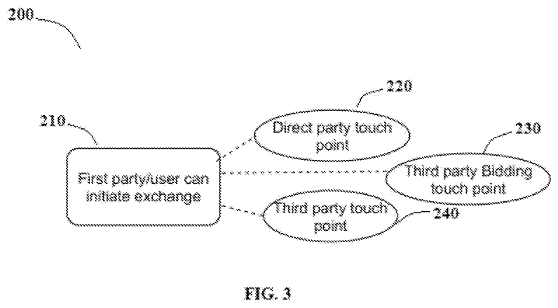

Referring to FIG. 3 now, which illustrates diagram of various forms or mediums of exchange of information 200, wherein the system 1000 through the computer implemented platform, provides a plurality of various mediums for exchange of information. According to present embodiment, the user or the first party which is sharing the information may initiate the exchange 210 through three different forms or modes as direct party touch point 220, third party touch bidding touch point 230 and third party touch point 240.

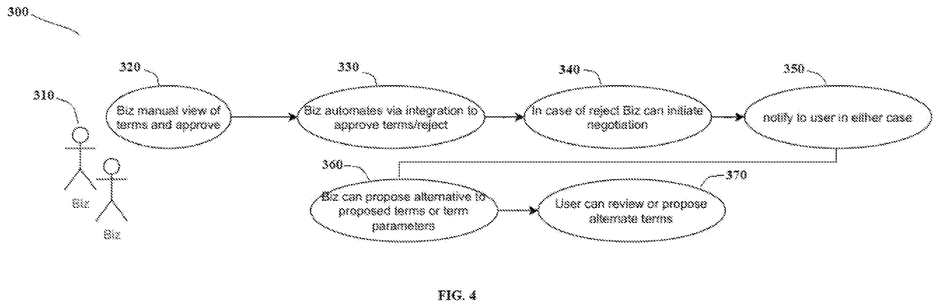

FIG. 4 shows a process flow diagram of terms agreement negotiation stage 300 between the parties of present invention. Under this stage, the computer implemented platform of present system 1000 allows business or second party which is requesting to access information to accept the terms of first party or negotiate in case the terms are not acceptable or not practical. According to present embodiment, the system allows second party (business) 310 to manually views and approve 320 the proposed terms by the first party, where the business/second party 310 automates via integration to approve and/or reject 330 the proposed terms. The system 1000 through the platform further provides a window to the business 310 for negotiation 340 in case the terms are not acceptable and also notifies the user 350 in all the cases. If the second party 310 rejects the terms, the platform allows the second party 310 to negotiate and propose alternative to proposed terms or terms parameters 360 which the platform notifies to the first party who can review the alternate proposed terms by the second party 310 and may accept or further propose alternate terms 370 which both the parties may accept to come on a deal to securely exchange the information.

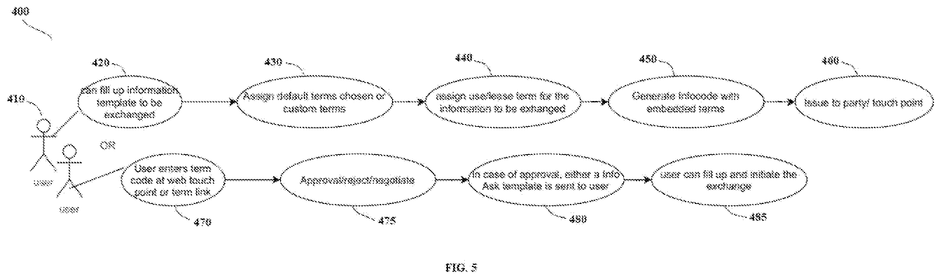

FIG. 5 illustrates view of a process flow diagram of stage of initiation of an information exchange 400 between the parties through the present web based platform. According to present embodiment, the computer implemented platform provides user 410 with a templates which user can fill up with an information to exchange 420, where the user 410 can choose a default terms or custom terms 430, assign use and/or lease terms for the information being exchanged 440 etc. The web based platform then generates infocode 450 with embedded terms of the user 410 and publishes or issues to party touch point 460.

According to present embodiment, to review the terms, the second party or user may enter infocode/term code at web touch point or may directly touch the term link over the web touch point 470, review the terms of the first user 410, and approve and/or reject and/or negotiate 475 the terms. In case of approval, the system 1000 sends the template of required information 480 to the first party 410, wherein the user/third party may fill up and initiate the information exchange 485.

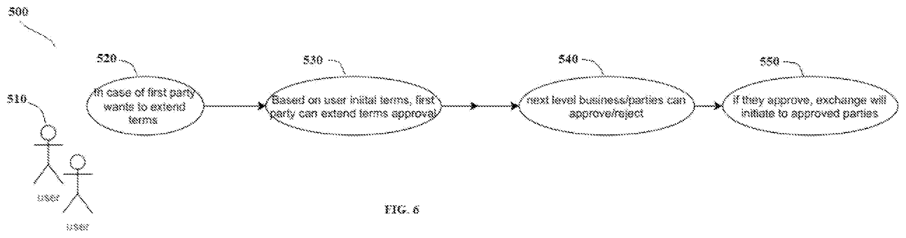

FIG. 6 shows process flow diagram of stage of multi-parties terms approval and information exchange 500, wherein the user/first party 510 may extend the terms 520 in case the first party wants to extend. Based on user initial terms, the first party may extend the term approval 530. According to one embodiment, multiple parties or next level business may approve or reject the terms 540, if the multi-parties approves, the information exchange initiates to all the approved parties 550 over the web based platform of present system 1000.

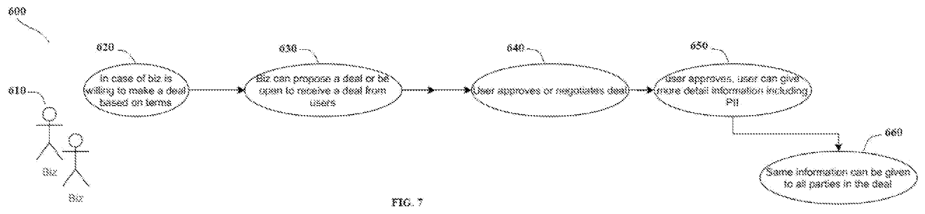

FIG. 7 shows process diagram of stage of advance information exchange and deal making 600. The system 1000 provides a platform to the business for exchange of advance information such as personal information (PII). The business 610, at this stage, can make a deal based on terms 620, in case the business 610 wills to do so, and may propose a specific deal to the user or may be open to receive a deal from a user 630 to which the user may approve and/or may negotiate deal 640. If the user approves the deal, the system 1000 allows user to provide more detailed information such as personal information (PIT) 650 over the platform. Further, the platform shares the same information to multiple parties 660 if all the parties are in the same deal.

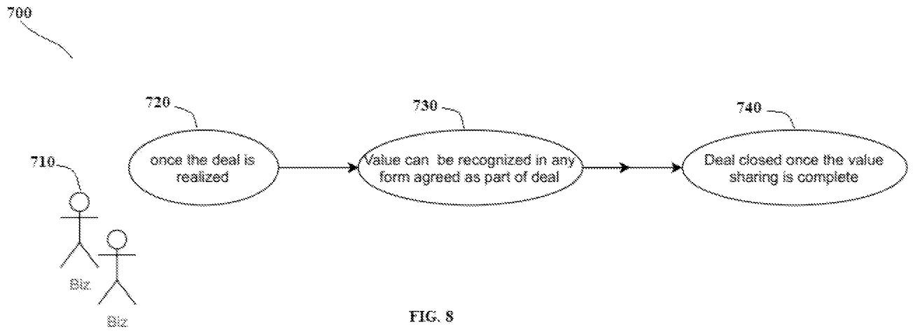

FIG. 8 shows a process diagram for deal realization and commerce 700 between the parties. According to present embodiment, the web based platform of present system 1000, based on the values recognized in any form agreed as part of the deal 730, shares the value or commercial benefit with the information sharing party once the deal is realized 720 between the parties 710 and closes the deal 740 once the commercial benefit or value is shared between the parties 710, as per the deal.

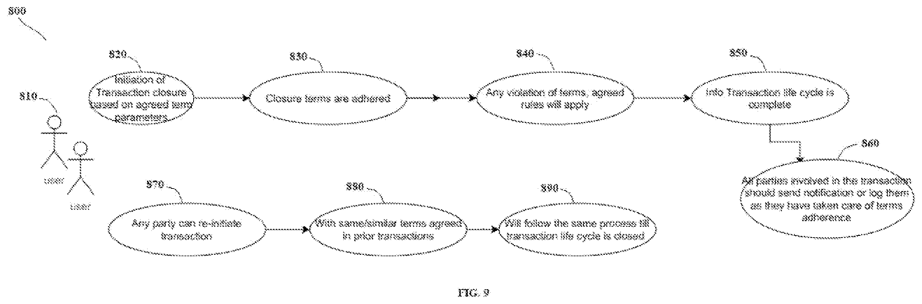

FIG. 9 shows view of process diagram of information exchange closure, completion or re-initiation 800. After completion of the deal, the system 1000 further allows completion or re-initiation of the process, where the users 810 are allowed to initiate transaction closure based on agreed terms parameters 820 with adhered closure terms. According to present embodiment, the platform applies agreed rules when any violation of terms are detected 840. According to present embodiment, once the information transaction cycle completes 850, all the parties involved in the transaction sends the notification over the platform or further allows parties to log as they have taken care of terms adherence.

According to present embodiment, the system allows any parties within the deal 810 to re-initiate the transaction 870 in case the parties wants to share the same information with the same second party or when the first party wishes to go into deal with similar or same terms agreed in prior transactions 880. According to present embodiment, when the user 810 wants a deal with same terms as prior transactions, the system 1000 follows the same process till transaction life cycle is closed 890.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method of working of a system for a term based information exchange comprising:
providing the system having a web based mediator platform for secure information exchange under the agreement of terms between a first user and a second user;
allowing the first user to access the web based mediator platform using any smart user device to select standard set of terms from the web based mediator platform or to create a custom terms;
scrutinizing by the web based mediator platform of the terms selected or custom created by the first user to check whether the terms are acceptable or not;
creation of a term link or a term code by the web based mediator platform with the terms selected or custom created by the first user;
allowing the first user to distribute or publish said term link or term code at different web touch points where the first user is present;
allowing the second user which is interested in consuming information of the first user to first access and review the terms of the first user via the term link or the term code through the web based mediator platform;
providing the second user to compare the terms of the first user with their own terms acceptance limit and accept the terms of the first user;
initiation of information exchange by the platform between the first user and the second user.

2. The method of working of a system for a term based information exchange of claim 1, wherein the first user may provide on demand the term link or term code to the second user to access the terms of the first user.

3. The method of working of a system for a term based information exchange of claim 1, wherein the web based mediator platform facilitates the first user and the second user who are in exchange of information to have dialogue over the web based mediator platform.

4. The method of working of a system for a term based information exchange of claim 1, wherein an information includes personal information (PII), social information, financial information and other special context based information.

5. The method of working of a system for a term based information exchange of claim 1, wherein the web based mediator platform allows the second user to negotiate the terms with the first user by proposing a new term, in case the terms of the first user is unacceptable.

6. The method of working of a system for a term based information exchange of claim 1, wherein the web based mediator platform provides three different forms or modes to the first user for information exchange initiation.

7. The method of working of a system for a term based information exchange of claim 6, wherein the three forms or modes includes direct party touch point, third party bidding touch point and third party touch point.

8. The method of working of a system for a term based information exchange of claim 1, wherein the web based mediator platform further shares a value or a commercial benefit with the first party depending on the agreed terms with completion of the information exchange.

9. A method of working of a system for a term based information exchange comprising:
providing the system made of a web based mediator platform accessible through any network enabled smart user device and a central server;
allowing the first user to access the web based mediator platform using any network enabled smart user device to select standard set of terms from the web based mediator platform or to create a custom terms;
scrutinizing by the web based mediator platform of the terms selected or custom created by the first user to check whether the terms are acceptable or not;
creation of a term link or a term code by the web based mediator platform with the terms selected or custom created by the first user;
allowing the first user to distribute or publish said term link or term code at different web touch points where the first user is present;
allowing the second user which is interested in consuming information of the first user to first access and review the terms of the first user via the term link or the term code through the web based mediator platform;
providing the second user to compare the terms of the first user with their own terms acceptance limit and accept the terms or reject the terms or negotiate by proposing a new term to the first user;
recommendation of templates for information exchange by the web based mediator platform after acceptance of the terms;
initiation of information exchange by the platform between the first user and the second user.

10. The method of working of a system for a term based information exchange of claim 9, wherein the recommends templates by the web based mediator platform is provided for the first user to fill up the context related information based on an agreed terms.

11. The method of working of a system for a term based information exchange of claim 9, wherein the network enabled smart user device is any of smartphone, computer, laptop or any other wearable smart device.

12. The method of working of a system for a term based information exchange of claim 9, wherein the web based mediator platform further allows a multiple users to initiate same set of the terms to other users for approval.

13. The method of working of a system for a term based information exchange of claim 9, wherein the web based mediator platform provides three different forms or modes to the first user for information exchange initiation.

14. The method of working of a system for a term based information exchange of claim 13, wherein the three forms or modes includes direct party touch point, third party bidding touch point and third party touch point.

15. The method of working of a system for a term based information exchange of claim 9, wherein the web based mediator platform further shares a value or a commercial benefit with the first party depending on the agreed terms with completion of the information exchange.
